(19) United States
(12) Patent Application Publication
(10) Pub. No.: US 2010/0237040 A1
(43) Pub. Date: Sep. 23, 2010

(54) Method for manufacturing glass stamper, glass stamper, and method for manufacturing magnetic recording medium

(75) Inventors: Yoshiyuki Kamata, Tokyo (JP); Akira Kikitsu, Kanagawa-ken (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/659,818

(22) Filed: Mar. 22, 2010

(30) Foreign Application Priority Data
Mar. 23, 2009 (JP) P2009-070578

(51) Int. Cl. C03B 11/00; B44C 1/22

(52) U.S. Cl. 216/22; 65/62; 425/470

(57) ABSTRACT

A method for manufacturing a glass stamper includes the following steps. First, a diamond film is formed on a substrate. A resist is applied onto the diamond film and a pattern is formed by performing electron beam lithography and development. The diamond film is etched with any one of oxygen and Ar gas using the pattern on the resist as a mask, thereby transferring the pattern to the diamond film. The resist and the substrate are removed to fabricate a diamond mold. Then, a glass stamper is manufactured by glass molding using the diamond mold.

### CROSS REFERENCE TO RELATED APPLICATION

This application is based upon and claims the benefit of priority from the prior Japanese Patent Application No. 2009-070578, filed on Mar. 23, 2009, the entire contents of which are incorporated herein by reference.

### FIELD OF THE INVENTION

The present invention relates to a method for manufacturing a glass stamper, a glass stamper manufactured using the method, and a method for manufacturing a magnetic recording medium using the glass stamper.

### DESCRIPTION OF THE BACKGROUND

In recent years, a problem has emerged in which improvement of track density is prevented by interference between adjacent tracks in a magnetic recording medium to be incorporated in a hard disk drive (HDD). In particular, it is an important technical challenge how to reduce a fringe effect in the magnetic field of a recording head.

Discrete track recording media (DTR media), in which recording tracks are physically separated, have been proposed to the problem. The DTR media allow it to reduce phenomena, such as a side erase phenomenon in which information of adjacent tracks is erased during writing, a side read phenomenon in which information of adjacent tracks is read during reading. Accordingly, the track density in the DTR media can be increased. Therefore, the DTR media are expected as high-density magnetic recording media.

In addition, bit patterned media (BPM) have been proposed as high-density magnetic recording media which can suppress thermal fluctuation and medium noise. Here, information is written into and read from the bit patterned media using a single magnetic dot as a single recording cell.

When DTR media or BPM are individually manufactured using an electron beam (EB) lithography technique, the manufacturing cost thereof significantly increases. In this regard, the following method has been employed in order to reduce the manufacturing cost. Specifically, a Ni stamper is fabricated from an original disk on which a fine pattern has been formed by the electron beam (EB) lithography. The fine pattern on the Ni stamper thus fabricated is imprinted and thus transferred to a resist applied onto a magnetic recording layer formed on a medium substrate. Then, the magnetic recording layer is etched along with the pattern.

The Ni stamper is fabricated as follows. An original disk is fabricated by applying a resist onto a stamper substrate, forming a fine pattern on the resist by the EB lithography, and developing the resist. The Ni stamper is fabricated by forming a Ni conducting film on the original disk by sputtering, depositing a Ni electroformed layer, and then separating the Ni electroformed layer and the Ni conducting film from the stamper substrate. A transparent electronic microscope (TEM) observation of the Ni conducting film revealed that Ni crystal grains having a grain size of 15 nm to 20 nm were grown in the Ni conducting film. For this reason, Ni crystal grains are grown also in the Ni electroformed layer deposited on the Ni conducting film. As a result, it was found that the pattern actually formed on the Ni stamper had line edge roughness (LER) defined by the grain size of the Ni crystal grains, and that the LER can be reduced only to approximately 5 nm.

The pattern is designed to have a size of 10 nm×20 nm for the BPM having a recording density of 2 Tbpsi, for example. However, a pattern having such a small size cannot be formed using a Ni stamper having a pattern with a LER of approximately 5 nm. Accordingly, a BPM having a recording density of 2 Tbpsi cannot be manufactured.

Conventionally, a stamper has been proposed in which at least the top surface of a convex portion is formed of a material having no crystalline peak in the X-ray diffraction in order to reduce LER (JP-A 005-133166 (KOKAI)). For example, the following method for fabricating a stamper having a pattern with a track pitch of 200 nm has been disclosed. Specifically, a concavo-convex pattern is formed on a silicon substrate. Then, a TaSi film is formed thereon as a conducting film, and a Ni electroformed layer is deposited thereon. Finally, the Ni electroformed layer and the TaSi film are separated. However, even with this method, there is a risk that the LER of a stamper cannot be reduced because of crystal grains in the grown Ni electroformed layer when the pattern width is reduced.

### SUMMARY OF THE INVENTION

According to a first aspect of the invention, a method for manufacturing a glass stamper includes the following steps. First, a diamond film is formed on a substrate. A resist is applied onto the diamond film and a pattern is formed by performing electron beam lithography and development. The diamond film is etched with any one of oxygen and Ar gas using the pattern on the resist as a mask, thereby transferring the pattern to the diamond film. The resist and the substrate are removed to fabricate a diamond mold. Then, a glass stamper is manufactured by glass molding using the diamond mold.

According to a second aspect of the invention, a glass stamper is manufactured by the method according to the first aspect.

According to a third aspect of the invention, a method for manufacturing a magnetic recording medium includes the following steps. First, a carbon protection film and a metal film are formed on a magnetic recording layer. A UV-curable resist is applied onto the metal film. Then, UV imprinting is performed using a glass stamper on the UV-curable resist, thereby transferring a pattern to the UV-curable resist. Here, the glass stamper is manufactured by the method according to the first aspect. The metal film and the carbon protection film are then etched using the pattern on the UV-curable resist as a mask to expose the magnetic recording layer. Then, a concave portion is formed in the magnetic recording layer by etching the magnetic recording layer while deactivating the magnetism of the exposed magnetic recording layer using He—N₂ gas.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a plan view illustrating a discrete track recording medium (DTR medium).

FIG. 2 is a plan view illustrating a bit patterned medium (BPM).

FIG. 3 is a cross-sectional view illustrating a method for manufacturing a glass stamper according to an embodiment of the present invention.

FIG. 4 is a schematic view illustrating Ni crystal grains in a Ni conducting film.

FIG. 5 is a perspective view illustrating a LER of a Ni stamper.

FIG. 6 is a cross-sectional view illustrating a surface roughness Ra of a mold.

FIG. 7 is a cross-sectional view illustrating a conventional method for fabricating a diamond mold.

FIG. 8 is a cross-sectional view illustrating a method for fabricating a diamond mold according to the present invention.

FIG. 9 is a cross-sectional view illustrating a method for manufacturing a magnetic recording medium (DTR medium or BPM) according to an embodiment of the present invention.

### DETAILED DESCRIPTION OF THE EMBODIMENTS

The inventors devised a method for manufacturing a DTR medium and a BPM having a recording density of 2 Tbpsi class without using a Ni stamper. In order to manufacture a DTR medium and a BPM having a recording density of 2 Tbpsi class, it is important to reduce LER of a stamper to be used for imprinting. Since the LER of a Ni stamper is determined in accordance with the Ni grain size of a conducting film as described above, a stamper made of another material needs to be prepared.

The inventors discovered that a glass stamper is most advantageous to reduce LER. The glass molding technique is preferable for fabricating a glass stamper at low cost (see, for example, Japanese Patent No. 400-4286). The glass molding is a method for molding a glass by casting glass heated to the softening point (650° C.) or higher into a mold. The mold for the glass molding is made of a material which can withstand a temperature higher than the softening point of the glass (650° C.) without deforming. In general, glassy carbon (GC) is used for the mold for the glass molding. However, the glassy carbon has a large surface roughness Ra, which is approximately 10 nm, and thus is not suitable for formation of fine patterns of 2 Tbpsi class. The inventors searched for a material capable of withstanding a high temperature of 650° C. or higher and having surface roughness Ra of several nm or less, and found that diamond is preferable. In the description, diamond is defined as a material which is confirmed to have a steep peak attributable to spa bonding at 1333 cm⁻¹ in a Raman spectroscopy and in which the peak intensity is not less than 1.5 times the peak intensity of graphite at 1580 cm⁻¹.

In the present invention, the line edge roughness (LER) is calculated by extracting an edge from an image of a scanning electron microscope (SEM). The surface roughness Ra is obtained by an atomic force microscope (AFM).

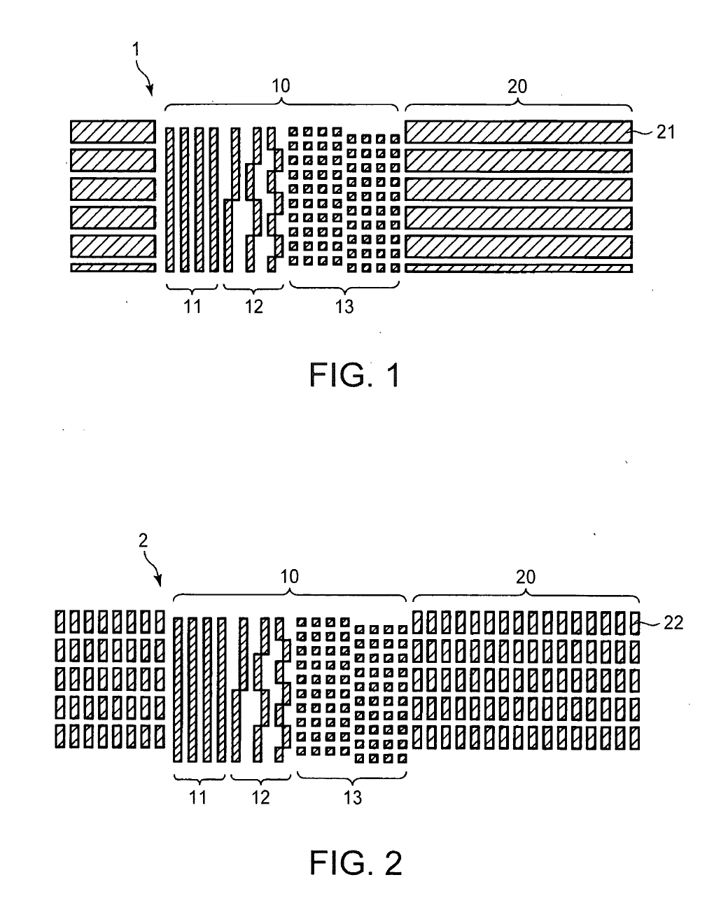

Embodiments of the present invention will be described hereinafter with reference to the accompanying drawings. FIG. 1 shows a plan view of a discrete track recording medium (DTR medium) 1 taken along a circumferential direction of the DTR medium 1. As shown in FIG. 1, servo regions 10 and data regions 20 are alternately formed along the circumferential direction of the medium 1. The servo region 10 includes a preamble section 11, an address section 12, and a burst section 13. The data region 20 includes discrete tracks 21 which are separated from one another.

FIG. 2 shows a plan view of a bit patterned medium (BPM) 2 taken along a circumferential direction of the BPM 2. As shown in FIG. 2, a servo region 10 of the BPM 2 has a configuration similar to that shown in FIG. 1. A data region 20 of the BPM 2 includes magnetic dots 22 which are separated from one another.

In the present invention, a glass stamper is manufactured in which a pattern corresponding to recording tracks or recording bits in the data region and a pattern corresponding to information in the servo region in the DTR medium 1 shown in FIG. 1 or in the BPM 2 shown in FIG. 2 are formed with convexes and concaves.

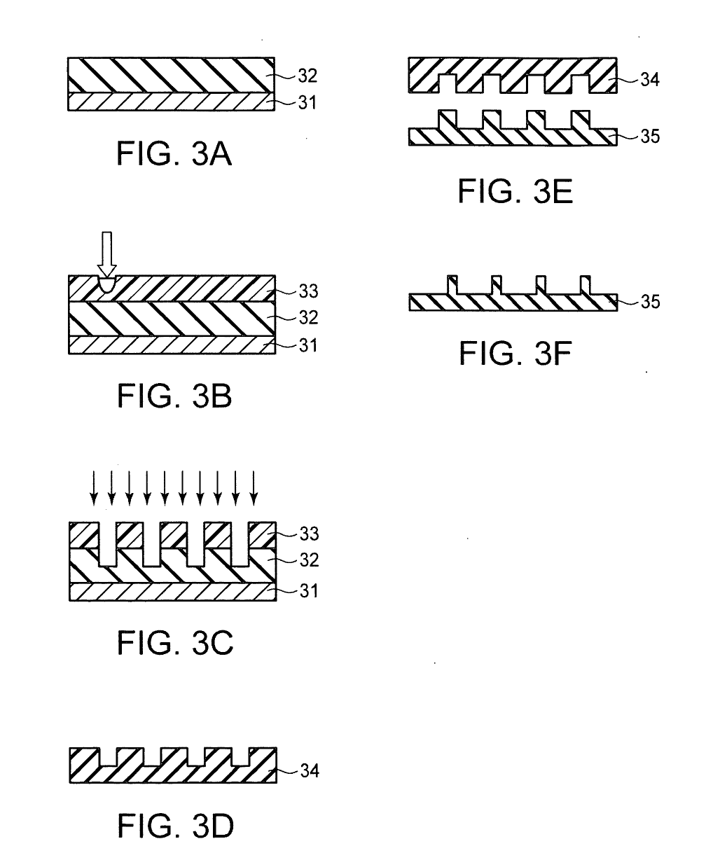

Next, a method for manufacturing a glass stamper according to the present invention will be described hereinafter with reference to FIGS. 3A to 3F.

As shown in FIG. 3A, a diamond film 32 having a thickness of 500 μm is formed on a Si substrate 31 of 4 to 6 inches by a CVD (Chemical Vapor Deposition) method. Mixed gas of methane (CH₄) and hydrogen (H₂) is used as a source gas, for example.

As shown in FIG. 3B, an electron beam (EB) resist 33 (for example, ZEP 520: Zeon Corporation) is applied onto the diamond film 32. Then, the pattern of the DTR medium 1 or the BPM 2 shown in FIG. 1 or FIG. 2 is formed using an EB lithography system. The patterns are developed using a developing solution (for example, ZED-N50: Zeon Corporation) to form the concavo-convex pattern on the EB resist 33 on the diamond film 32.

As shown in FIG. 3C, a portion of the diamond film 32 is etched by oxygen RIE (Reactive Ion Etching) using the pattern of the EB resist 33 as a mask.

As shown in FIG. 3D, a diamond mold 34 is fabricated by removing the Si substrate 31 and the remained EB resist 33 using hydrofluoric acid.

The method of the present invention is advantageous in that the etching of the diamond film 32 by the oxygen RIE reduces the LER of the diamond mold 34.

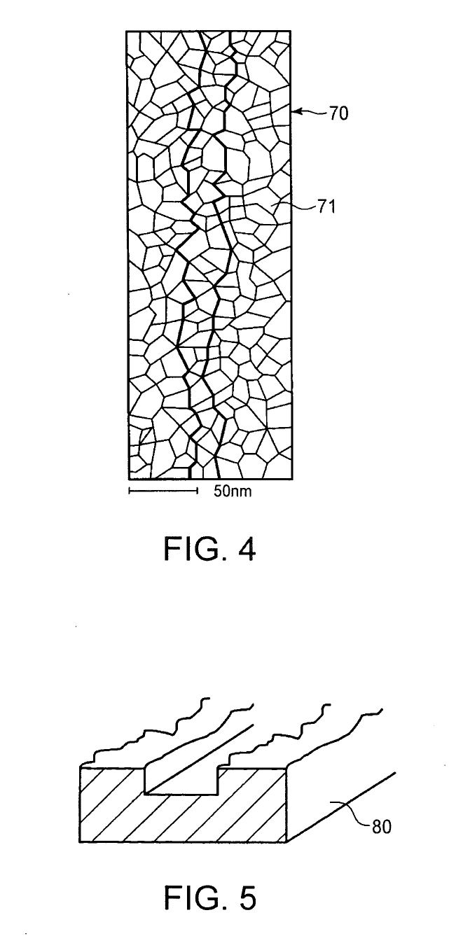

In the case of a conventional Ni stamper, a Ni film is formed as a conducting film on a pattern of an EB resist by sputtering after the EB resist is subjected to the EB lithography and development. As shown in the schematic view of FIG. 4, Ni crystal grains 71 having a grain size of 15 nm to 20 nm are grown in a Ni conducting film 70. For this reason, even when a linear pattern is formed on the substrate, convexes and concaves are formed on a pattern of the Ni conducting film in accordance with the shapes of the Ni crystal grains. Furthermore, as shown in the perspective view of FIG. 5, a LER corresponding to the grain size of the Ni crystal grains is generated in a Ni stamper 80 fabricated by growing a Ni electroformed layer on the Ni conducting film and separating the Ni electroformed layer and the Ni conducting film.

In the method of the present invention, a diamond film is etched. Accordingly, unlike the Ni stamper, the LER is not determined by the grain size of the Ni crystal grains, and LER generated at the time of the EB lithography can be maintained as it is. In addition, as a result of an effect of oxygen plasma, edge smoothing is also expected. Thus, although it was difficult to reduce LER to 5 nm or lower with the conventional Ni stamper, the present invention is capable of easily forming a pattern with LER of 5 nm or lower, and further, is capable of forming a pattern with LEF of 1 nm or lower.

In addition, if nitrogen gas is mixed in the etching of the diamond film 32 by the oxygen RIE, the surface of the diamond mold 34 can be easily azotized using the doping effect of nitrogen atoms. The azotized diamond mold 34 has a hardened surface, and thus, the protection resistance thereof to particles, dust and the like in the air is improved. Additionally, the durability of the diamond mold 34 itself can be improved. Using fluorine-containing gas (CF₄, CHF₃, C₂H₆, SF₆ or the like) instead of nitrogen allows the surface of the diamond mold 34 to be fluorinated as a result of the doping effect of fluorine atoms. The fluorination has the effect of improving releasability of the diamond mold 34 from the molded glass stamper.

Alternatively, the method of etching the diamond film 32 is not necessarily limited to the oxygen RIE, and may be ion beam etching using Ar gas.

Moreover, the plasma method to be used may be of a parallel plate type, an ICP (Inductively Coupled Plasma) type, an ECR (Electron Cyclotron Resonance) type, or the like.

As shown in FIG. 3E, the diamond mold 34 fabricated using the above-described method is set in a glass molding machine to fabricate a glass stamper 35 at a molding temperature of 650° C. with a molding pressure of 2 MPa for a holding time of 5 minutes.

As shown in FIG. 3E, a step of slimming the pattern of the glass stamper 35 thus fabricated may be performed as needed. The term “slimming” means to reduce the width of each convex portion of the pattern by a wet etching process, a dry etching process, or the like. For example, a method in which the glass stamper 35 is dipped in hydrofluoric acid to reduce the size of the pattern by 5 nm to 10 nm as a whole may be used.

The pattern of the conventional Ni stamper can also be reduced by 5 nm to 10 nm as a whole by a similar slimming step in which the Ni stamper is dipped in, for example, sulfamic acid of a pH of approximately 3. However, LER (shown in FIG. 5) defined by the grain size of Ni crystal grains remains in the stamper, leading to a large variation in land width.

On the other hand, the glass stamper 35 of the present invention has a small LER. For this reason, the variation in land width can be made smaller even when the stamper slimming step is performed.

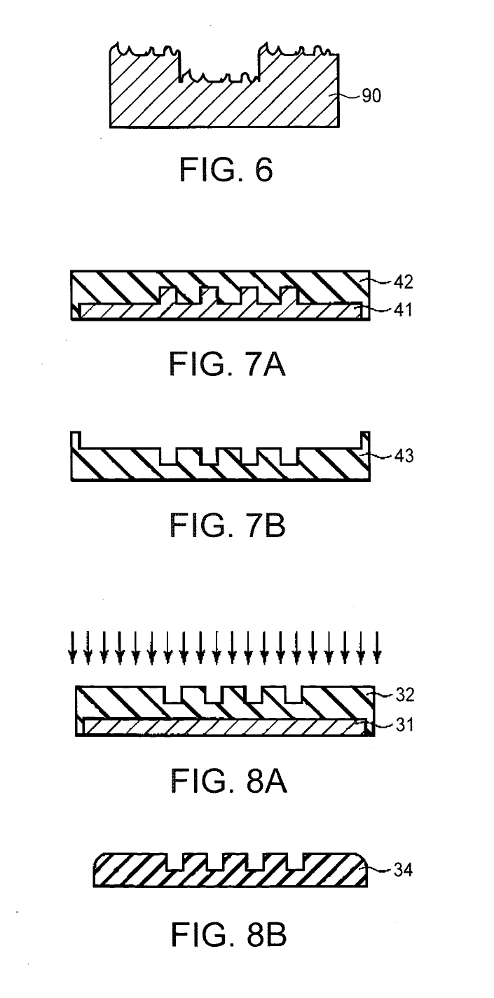

A challenge in a general glass molding is to release a molded glass from a mold. Consider a case where a mold 90 has a large surface roughness Ra as shown in FIG. 6. In this case, the glass “bites” into the mold due to a difference in thermal expansion coefficient between the glass and the mold when the glass molded at a high temperature is cooled down. This biting makes it significantly difficult to release the glass from the mold. Application of a mold release agent onto a mold as in a room-temperature imprinting cannot be employed in the glass molding as a generally-used fluorine mold release agent is decomposed at a high temperature. Then, Japanese Patent No. 4004286 discloses a method for improving the mold releasability by reducing the surface roughness Ra of a mold. However, such a complicated pattern as shown in FIG. 1 or FIG. 2 is formed on the diamond mold 34 to be used for the manufacture of the DTR medium or BPM. For this reason, only a reduction of the surface roughness Ra of the diamond mold 34 does not facilitate the releasing of the glass stamper 35 from the mold. As a result of further study, the inventors found that the mold releasability of the glass stamper 35 can be significantly improved by reducing the LER of the pattern on the diamond mold 34 in addition to the reduction of the surface roughness Ra of the diamond mold 34. At the same time, the inventors also found that this approach can considerably extend the life of the diamond mold 34.

Next, differences between the present invention and the conventional techniques will be described more in detail.

When a diamond mold is fabricated by the conventional technique, a method as shown in FIGS. 7A and 7B may be adopted. First, as shown in FIG. 7A, an EB resist is applied onto a Si substrate 41, and then, a pattern of the EB resist is formed through EB lithography and development. The pattern is transferred by etching the Si substrate 41 with RIE using fluorinated gas such as CF₄. A diamond film 42 is formed on the Si substrate 41 by CVD. As shown in FIG. 7B, a diamond mold 43 is fabricated by separating the Si substrate 41 using hydrofluoric acid. When the conventional technique is used, diamond which has been deposited onto a sidewall of the Si substrate 41 in the CVD step in FIG. 7A remains as a burr after the hydrofluoric acid treatment in FIG. 7B, and the burr cannot be removed. If a glass stamper is manufactured using such a diamond mold 43 having a burr, the burr forms a depressed portion in the glass stamper, which is then transferred as a defective pattern to the DTR medium or BPM.

In the method of the present invention, a diamond mold is fabricated as shown in FIGS. 8A and 8B. As shown FIG. 8A, a diamond film 32 is formed on a Si substrate 31. An EB resist is applied onto the diamond film 32, which is subjected to EB lithography and development to form a concavo-convex pattern on the EB resist. A portion of the diamond film 32 is etched by oxygen RIE using the pattern of the EB resist as an etching mask to transfer the concavo-convex pattern to the diamond film 32. In the oxygen RIE step, diamond which has deposited onto a sidewall of the Si substrate 31 is also etched. The EB resist is removed. As shown in FIG. 8B, the Si substrate 31 and the remained EB resist are removed using hydrofluoric acid to fabricate a diamond mold 34. Then, the diamond which was deposited onto the sidewall of the Si substrate 31 is etched, thereby giving rise to no burr at the edge portions of the diamond mold 34.

In the conventional method shown in FIGS. 7A and 7B, the diamond film 42 is deposited on the Si substrate 41 having convexes and concaves formed thereon, the diamond film 42 is deposited with non-uniform film quality in accordance with the thickness of the diamond film 42. Consequently, the residual stress in the fabricated diamond mold 43 cannot be completely relieved, and thus, the diamond mold 43 is likely to be broken when the glass stamper is molded. On the other hand, in the method of the present invention, since the diamond film 32 is formed on the flat Si substrate 31, residual stress is unlikely to be generated, so that the diamond mold 34 having a high durability can be formed.

Moreover, azotizing the surface of the diamond mold 43 for hardening by the conventional method brings about an increase in manufacturing cost. This is because an additional step such as nitrogen plasma exposure or nitrogen ion implantation is needed after the separating of the Si substrate using hydrofluoric acid. On the other hand, according to the method of the present invention, the surface of the diamond mold can be azotized and hardened by a simple method including mixing nitrogen gas or switching a process gas to nitrogen during the etching of the diamond surface in the plasma process, such as the oxygen RIE.

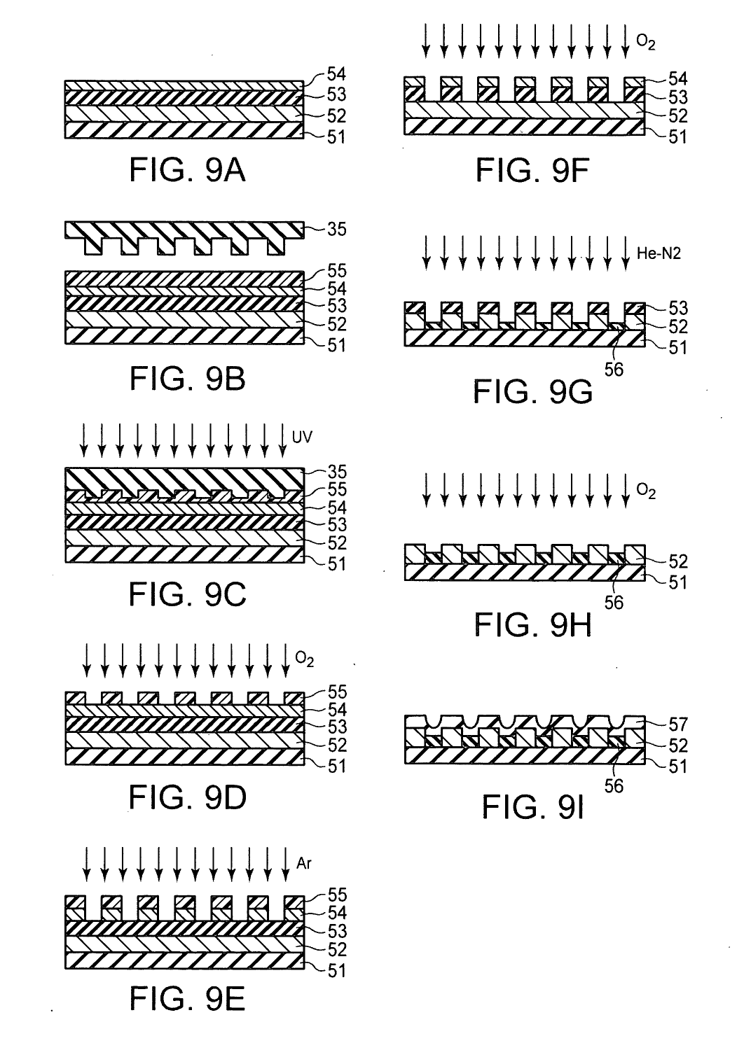

Next, a method of manufacturing a magnetic recording medium according to the present invention will be described with reference to FIGS. 9A to 9I. This method uses a glass stamper manufactured by the glass molding using a diamond mold as described above.

As shown in FIG. 9A, a soft magnetic underlayer (not shown) including CoZrNb and having a thickness of 120 nm, an underlayer for orientation control (not shown) including Ru and having a thickness of 20 nm, a magnetic recording layer 52 including CoCrPt—SiO₂ and having a thickness of 15 nm, a 15-nm-thick carbon protection film 53 having a thickness of 15 nm, and a metal layer 54 having a thickness of 3 nm to 5 nm are formed sequentially on a glass substrate 51. Here, the soft magnetic underlayer and the orientation controlling underlayer are not shown for simplicity.

For the metal layer 54, used is a metal which adheres well to an UV-curable resist (photopolymer agent, 2P agent) to be described later and which can be completely detached when etching using He—N₂ gas to be described later. Specifically, the metal is selected from the group consisting of CoPt, Cu, Al, NiTa, Ta, Ti, Si, Cr, and NiNbZrTi. Particularly, CoPt, Cu, and Si are excellent in both adhesion to the UV-curable resist and detachability by the He—N₂ gas.

As shown in FIG. 9B, the metal layer 54 is spin-coated with a UV-curable resist 55 to have a resist thickness of 50 nm. The UV-curable resist 55 contains a monomer, an oligomer, and a polymerization initiator, and is ultraviolet curable. For example, a composition containing 85% of isobornyl acrylate (IBOA) as the monomer, 10% of polyurethane diacrylate (PUDA) as an oligomer, and 5% of DAROCUR 1173 as the polymerization initiator may be used as the UV-curable resist 55. The glass stamper 35 is placed to face the UV-curable resist 55.

As shown in FIG. 9C, UV imprinting is performed using the glass stamper 35 to form convex portions of the UV-curable resist 55 as corresponding to concaves of the glass stamper 35. After that, the UV-curable resist 55 is irradiated with ultraviolet rays through the glass stamper 35 to be cured.

As shown in FIG. 9D, after the glass stamper 35 is removed, a resist residue remained on the bottom of the concaves of the patterned UV-curable resist 55 are removed. For example, an ICP (Inductively coupled Plasma) etching apparatus is used, where oxygen is introduced as a process gas, the chamber pressure is set at 2 mTorr, each of the coil RF power and platen RF power is set at 100 W, and the etching time is set at 30 seconds.

As shown in FIG. 9E, the metal layer 54 is etched by ion beam etching using Ar gas with the pattern of the UV-curable resist 55 as a mask. This step is not necessarily performed. For example, the resist residue and the metal layer can be etched by employing conditions for highly anisotropic etching in the removal of the resist residue. Specifically, the platen RF power is increased up to approximately 300 W in the ICP etching apparatus to improve the etching anisotropy. When Si is used for the metal layer 54, the metal layer 54 may be etched using CF₄ gas.

As shown in FIG. 9F, the carbon protection film 53 is patterned using the pattern of the UV-curable resist 55 as a mask. For example, the ICP etching apparatus is used, where O₂ is introduced as a process gas, the chamber pressure is set at 2 mTorr, each of the coil RF power and platen RF power is set at 100 W, and the etching time is set at 30 seconds.

As shown in FIG. 9G, ion beam etching is performed using He or He—N₂ (mixing ratio of 1:1) with the pattern of the carbon protection film 53 as a mask. Thereby, a portion of the magnetic recording layer 52 is etched to form convexes and concaves, and the magnetism of the magnetic recording layer 52 remained in the concaves is deactivated to form a nonmagnetic layer 56. In this step, an ECR (Electron Cyclotron Resonance) ion gun is preferably used. For example, the etching is performed for 20 seconds with a microwave power of 800 W and an acceleration voltage of 1000 V. Thereby, concaves having a depth of 10 nm are formed in the magnetic recording layer 52, and the nonmagnetic layer 56 which has a thickness of 5 nm and whose magnetism is deactivated is formed. Simultaneously, the remained metal layer (Cu, for example) 54 is removed. This is because the carbon protection film 53 cannot be detached using the oxygen RIE in the next step if the metal layer 54 remains.

As shown in FIG. 9H, the pattern of the carbon protection film 53 is removed. For example, RIE (Reactive Ion Etching) is performed using oxygen gas under the conditions of 100 mTorr, 100 W, and an etching time of 30 seconds.

As shown in FIG. 9I, a surface protection film 57 including carbon is formed to have a thickness of 4 nm by the CVD (Chemical Vapor Deposition) method. A lubricant is applied onto the surface protection film 57, so that a DTR medium or a BPM is manufactured.

Hereinafter, materials and individual steps to be used in the present invention will be described in detail.

### UV-Curable Resist

A UV-curable resist (2P agent) is an ultraviolet curable material, and includes a monomer, an oligomer, a polymerization initiator, and no solvent.

The followings may be used as the monomer:

Examples of Acrylates include Bisphenol A-ethylene oxide modified diacrylate (BPEDA), Dipentaerythritol hexa(penta)acrylate (DPEHA), Dipentaerythritol monohydroxy pentaacrylate (DPEHPA), Dipropylene glycol diacrylate (DPGDA), Ethoxylated trimethylol propane triacrylate (ETMPTA), Glyceryl propoxy triacrylate (GPTA), 4-hydroxybutyl acrylate (HBA), 1,6-hexanediol diacrylate (HDDA), 2-hydroxyethyl acrylate (HEA), 2-hydroxypropyl acrylate (HPA), Isobornyl acrylate (IBOA), Polyethylene glycol diacrylate (PEDA), Pentaerythritol triacrylate (PETA), Tetrahydrofurfuryl acrylate (THFA), Trimethylolpropane triacrylate (TMPTA), and Tripropylene glycol diacrylate (TPGDA).

Examples of Methacrylates include Tetraethylene glycol dimethacrylate (4EDMA), Alkyl methacrylate (AKMA), Allyl methacrylate (AMA), 1,3-butylene glycol dimethacrylate (BDMA), n-butyl methacrylate (BMA), Benzyl methacrylate (BZMA), Cyclohexyl methacrylate (CHMA), Diethylene glycol dimethacrylate (DEGDMA), 2-ethylhexyl methacrylate (EHMA), Glycidyl methacrylate (GMA), 1,6-hexanediol dimethacrylate (HDDMA), 2-hydroxyethyl methacrylate (2-HEMA), Isobornyl methacrylate (IBMA), Lauryl methacrylate (LMA), Phenoxyethyl methacrylate (PEMA), t-butyl methacrylate (TBMA), Tetrahydrofurfuryl methacrylate (THFMA), and Trimethylol propane trimethacrylate (TMPMA).

Particularly, isobornyl acrylate (IBOA), tripropylene glycol diacrylate (TPGDA), 1,6-hexanediol diacrylate (HDDA), dipropylene glycol diacrylate (DPGDA), neopentyl glycol diacrylate (NPDA), ethoxylated isocyanuric acid triacrylate (TITA), and the like are favorable because they can provide a viscosity of 10 cP or lower.

Examples of the oligomer include: urethane acrylate materials, such as polyurethane diacrylate (PUDA) and polyurethane hexaacrylate (PUHA); polymethyl methacrylate (PMMA); polycarbonate diacrylate; methyl methacrylate polycarbonate fluoride (PMMA-PC-F); and the like.

Examples of the polymerization initiator include IRGACURE 184 manufactured by Ciba-Geigy Co. and DAROCUR 1173 manufactured by Ciba-Geigy Co., and the like.

### Surface Protection Film

The surface protection film is provided in order to prevent corrosion of a vertical magnetic recording layer and to protect the surface of a medium from getting damage when a magnetic head comes to be in contact with the medium. Examples of materials for the surface protection film include a material containing carbon (C), SiO₂, ZrO₂. Carbons are divided into sp²-bonded carbon (graphite) and sp³-bonded carbon (diamond). The sp³-bonded carbon is superior to graphite in durability and corrosion resistance, but is inferior to graphite in surface smoothness because the sp³-bonded carbon is crystalline. Usually, a carbon film is formed by sputtering using a graphite target. Using this method, an amorphous carbon with sp²-bonded carbon and sp³-bonded carbon mixed is formed. An amorphous carbon containing a high percentage of sp³-bonded carbon is referred to as a diamond-like carbon (DLC), and is excellent in durability and corrosion resistance. The DLC is also excellent in surface smoothness because the DLC is amorphous. In the formation of a DLC film by CVD (Chemical Vapor Deposition), DLC is generated by exciting and decomposing a source gas in plasma, followed by chemical reaction. Accordingly, DLC with a higher content of sp³-bonded carbon can be formed under appropriately set conditions.

### Removal of Residue

Any residue remained at the bottoms of the convexes in the resist is removed by RIE (Reactive Ion Etching). Although the ICP (Inductively Coupled Plasma) capable of generating low-pressure, high-density plasma is preferable as the plasma source, the ECR (Electron Cyclotron Resonance) plasma or the generally-used parallel plate type RIE apparatus may be used alternatively. Oxygen gas is preferably used to remove the residue of the UV-curable resist (2P agent).

### Magnetism Deactivation Etching

The depth of convexes and concaves is preferably 10 nm or lower when the flying performance of a read/write head is taken into consideration. However, the film thickness of the magnetic recording layer should be approximately 15 nm in order to ensure signal output. Hence, if 10 nm out of the film thickness 15 nm of the magnetic recording layer is physically removed and the remained 5 nm is magnetically deactivated, the side erase and the side read can be suppressed with ensuring the flying performance of the read/write head. Consequently, the DTR medium or BPM can be manufactured with suppressing the side erase and the side read. As a method for magnetically deactivating the magnetic recording layer having a thickness of 5 nm, a method is used in which the magnetic recording layer is exposed to ions of He or N₂. When exposing the magnetic recording layer to He ions, Hc (coercive force) decreases with the squareness of a hysteresis loop maintained in accordance with the exposure time, and eventually hysteresis is lost (magnetism deactivation). In this case, if the exposure time of He gas is insufficient, hysteresis with excellent squareness (having Hn (reverse nucleation field)) is retained. However, this means that the magnetic layer at the bottoms of the concaves still has a recording capability, and the advantages of the DTR medium or BPM are lost. On the one hand, when exposing to N₂ ions, the squareness of the hysteresis loop deteriorates in accordance with the exposure time, and eventually, hysteresis is lost. In this case, although Hn deteriorates rapidly, Hc is unlikely to decrease. However, if the exposure time of N₂ gas is insufficient, the magnetic layer with a large Hc remains at the bottom of the concaves and the advantages of the DTR medium or BPM are lost. Then, He—N₂ mixed gas is used when focusing on the fact that the behavior of the magnetism deactivation by He gas differs from that by N₂ gas. Thereby, the magnetism of the magnetic recording layer at the bottom of the concaves can be efficiently deactivated while the magnetic recording layer is etched.

### Detachment of Carbon Protection Film

After the magnetism of the magnetic recording layer is deactivated, the carbon protection film is detached. The carbon protection film can be easily detached by oxygen plasma.

### Formation and Post-Processing of Surface Protection Film

Lastly, a surface protection film including carbon is formed. Although the surface protection film is desirably formed by CVD in order to improve the coverage of convexes and concaves, the sputtering method or the vacuum deposition method may be used instead. DLC containing a large amount of sp³-bonded carbons can be formed using the CVD method. When the film thickness of the surface protection film is less than 2 nm, the coverage is poor. On the other hand, a film thickness exceeding 10 nm is not preferable because the magnetic spacing between the head and the medium becomes large, thereby reducing SNR. A lubricant is applied onto the surface protection film. As the lubricant, perfluoropolyether, fluorinated alcohol, fluorinated carboxylic acid or the like may be used.

### Example 1

A glass stamper was manufactured by the method shown in FIG. 3. A diamond film having a thickness of 500 μm was formed on a 6-inch Si substrate by the CVD. The surface of the diamond film was observed by an AFM (Atomic Force Microscope). It was thus found that the surface roughness Ra was 0.65 nm. An EB resist was applied on the diamond film to have a thickness of 40 nm by spin-coating. The pattern of a DTR medium as shown in FIG. 1 was formed using an EB lithography system, and was developed to form a concavo-convex pattern on the EB resist. A portion of the diamond film was etched by oxygen RIE using the pattern of the EB resist as an etching mask, so that the pattern was transferred to the diamond film. The Si substrate and the remained EB resist were removed using hydrofluoric acid, so that a diamond mold was fabricated. The pattern of the diamond mold thus fabricated had a convex width of 50 nm, a concave width of 25 nm, a track pitch of 75 nm, an LER of 0.70 nm, and a surface roughness Ra of 0.65 nm.

The diamond mold thus fabricated was set in the glass molding machine, and a glass stamper was manufactured at a molding temperature of 650° C. with a molding pressure of 2 MPa for a holding time of 5 minutes. Although 20 glass stampers were successively manufactured, no molding defective product was obtained. The pattern of the glass stampers obtained had a convex width of 25 nm, a concave width of 50 nm, a track pitch of 75 nm, a LER of 0.70 nm, and a surface roughness Ra of 0.65 nm.

As mentioned above, the diamond mold and the glass stamper had the same values of LER and Ra, and therefore, a favorable glass molding was achieved.

When UV imprinting was performed on a UV-curable resist (2P agent) using the glass stamper thus obtained, the pattern was allowed to be transferred for 50 consecutive times. In the 51th UV imprinting, dust of the UV-curable resist was left on the glass stamper. It was possible for the glass stamper to be made reusable by dipping the glass stamper in a mixed solution of sulfuric acid and hydrogen peroxide, followed by rinsing with pure water.

On the other hand, if dust of the resist is left on the Ni stamper, the stamper cannot be made reusable any more. Imprinting using the Ni stamper with dust left results in a pattern loss.

### Example 2

A glass stamper was manufactured by the same method as that used for Example 1. Thereafter, the glass stamper was dipped in hydrofluoric acid for 30 minutes to be slimmed. The pattern of the glass stamper thus obtained had a convex width of 15 nm, a concave width of 60 nm, a track pitch of 75 nm, a LER of 0.70 nm, and a surface roughness Ra of 0.65 nm. The glass stamper in Example 2 can be slimmed to have a convex width smaller by 10 nm than that of the glass stamper of Example 1, and also keep the same LER and surface roughness Ra as those of the glass stamper of Example 1.

On the other hand, although the convex width of the Ni stamper can also be reduced by 10 nm by dipping the Ni stamper in sulfamic acid for 30 minutes for slimming, the LER of the Ni stamper becomes very large, that is, approximately 3 nm to 5 nm.

### Example 3

A glass stamper was manufactured with the same method as that used for Example 1. Glass stampers each having a DTR pattern of a pattern size (convex width) of 15 nm were manufactured by glass molding using diamond molds having various values of LER and Ra. Glass molding was performed 20 times, and the yields of the glass stampers were determined. Table 1 shows the yields.

The following is found from Table 1. When both LER and Ra are 1 nm or less, the mold releasability of the glass stampers from the diamond mold is good, so that the glass stampers can be manufactured with a yield of approximately 100%. However, when either of Ra and LER exceeds 1 nm, the yield of the glass stampers drops to 60% or lower.

On the other hand, when the glass stampers having a pattern size (convex width) of 20 nm or higher were manufactured by glass molding using the diamond molds, the yield of the glass stampers was almost 100% irrespective of the values of LER and Ra.

TABLE 1
Relationship among Ra and LER, Yield Number and Percentage
of Glass Stampers in the case of a convex width of 15 nm.

| | | Ra | | | |
|---|---|---|---|---|---|
| | | 0.65 nm | 1.00 nm | 2.00 nm | 4.00 nm |
| LER | 0.70 nm | 20 (100%) | 20 (100%) | 7 (35%) | 3 (15%) |
| | 1.00 nm | 20 (100%) | 19 (95%) | 5 (25%) | 1 (5%) |
| | 2.00 nm | 10 (50%) | 12 (60%) | 2 (10%) | 0 |
| | | | | | Unmoldable |
| | 4.00 nm | 3 (15%) | 1 (5%) | 0 | 0 |
| | | | | Unmoldable | Unmoldable |

### Example 4

A glass stamper was manufactured by the same method as that used for Example 2. The pattern of the glass stamper thus obtained had a convex width of 15 nm, a concave width of 60 nm, a track pitch of 75 nm, a LER of 0.70 nm, and a surface roughness Ra of 0.65 nm. A DTR medium was fabricated using this glass stamper by the method shown in FIG. 9. Cu was used as the metal layer 54. The pattern of the DTR medium thus obtained had a land width of 57 nm, a groove width of 18 nm, a track pitch of 75 nm, and a recess depth of 10 nm. A surface protection film including carbon was formed on the fabricated DTR medium, and a lubricant was applied thereon. Then, the DTR medium was incorporated into a hard disk drive and subjected to a glide test. As a result, the DTR medium passed the glide test with an 8-nm flying head.

The bit error rate (BER) of the DTR media incorporated into the hard disk drive was measured on track and was 10^{-5.0}. The positioning accuracy of the read/write head was 6 nm. In addition, the fringe resistance was evaluated in the following manner. The BER was measured after recording on a center track. Then, after recording on adjacent tracks 100,000 times, the BER of the center track was measured again to check if there was any decrease in the BER. As a result, no degradation was observed in the BER and it was found that the DTR medium had favorable fringe resistance. It was found that the DTR medium fabricated by the manufacturing method of the present invention had a good flying performance, favorable head positioning accuracy, and an excellent fringe resistance.

### Example 5

A glass stamper was manufactured in the same manner as that in Example 1, except that the pattern corresponding to the bit patterned medium (BPM) as shown in FIG. 2 was formed using the EB lithography system. A BPM was fabricated using this glass stamper by the same method as that used for Example 4. The bit size of the fabricated BPM was 57 nm×20 nm.

A signal amplitude intensity was evaluated because BER was not defined for BPM. The BPM was magnetized in one direction and incorporated into the drive, and the reproduced waveform was observed. Thereby, the signal amplitude intensity was found to be 200 mV. The head positioning accuracy of the read/write head was 6 nm. Consequently, it was found that the BPM was also be able to be fabricated by the same fabrication method as that used for fabricating the DTR medium.

What is claimed is:

1. A method for manufacturing a glass stamper, comprising the steps of:
forming a diamond film on a substrate;
applying a resist onto the diamond film to form a pattern by performing electron beam lithography and development;
etching the diamond film using any one of oxygen and Ar gas with the pattern on the resist as a mask to transfer the pattern to the diamond film;
removing the resist and the substrate to fabricate a diamond mold; and
manufacturing a glass stamper by glass molding using the diamond mold.

2. The method according to claim 1, further comprising the step of slimming the manufactured glass stamper.

3. A glass stamper manufactured by a method for manufacturing a glass stamper, the method including the steps of:
forming a diamond film on a substrate;
applying a resist onto the diamond film to form a pattern by performing electron beam lithography and development;
etching the diamond film using any one of oxygen and Ar gas with the pattern on the resist as a mask to transfer the pattern to the diamond film;
removing the resist and the substrate to fabricate a diamond mold; and
manufacturing a glass stamper by glass molding using the diamond mold.

4. The glass stamper according to claim 3, wherein the pattern having a surface roughness of 1 nm or lower and a line edge roughness of 1 nm or lower is formed.

5. A method for manufacturing a magnetic recording medium, comprising the steps of:
forming a carbon protection film and a metal film on a magnetic recording layer;
applying a UV-curable resist onto the metal film;
performing UV imprinting using a glass stamper on the UV-curable resist to transfer a pattern to the UV-curable resist, the glass stamper being manufactured by a method for manufacturing a glass stamper, the method including the steps of:
forming a diamond film on a substrate;
applying a resist onto the diamond film to form a pattern by performing electron beam lithography and development;
etching the diamond film using any one of oxygen and Ar gas with the pattern on the resist as a mask to transfer the pattern to the diamond film;
removing the resist and the substrate to fabricate a diamond mold; and
manufacturing a glass stamper by glass molding using the diamond mold;
etching the metal film and the carbon protection film using the pattern on the UV-curable resist as a mask to expose the magnetic recording layer; and
forming a concave portion in the magnetic recording layer by etching the magnetic recording layer while deactivating a magnetism of the exposed magnetic recording layer using He—N₂ gas.

6. The method according to claim 5, wherein the metal layer includes a material selected from the group consisting of NiTa, Ta, Pt, Al, Ti, Si, CoPt, Cu, and nitrides thereof.
